(19) United States
(12) Patent Application Publication
(10) Pub. No.: US 2022/0318625 A1
(43) Pub. Date: Oct. 6, 2022

(54) DYNAMIC ALERT PRIORITIZATION METHOD USING DISPOSITION CODE CLASSIFIERS AND MODIFIED TVC

(71) Applicant: Johnson Controls Tyco IP Holdings LLP, Milwaukee, WI (US)

(72) Inventors: Eamonn Jerry O'Toole, Cork (IE); Jane Delaney, Cork (IE); Andrew Keane, Killarney (IE)

(21) Appl. No.: 17/709,003

(22) Filed: Mar. 30, 2022

Related U.S. Application Data
(60) Provisional application No. 63/168,999, filed on Mar. 31, 2021.

(51) Int. Cl. G06N 3/08

(52) U.S. Cl. CPC G06N 3/08

(57) ABSTRACT

A building security system includes one or more memory devices configured to store instructions that, when executed by one or more processors, cause the one or more processors to receive multiple alerts relating to a building, the multiple alerts include alert types. The instructions further cause the one or more processors to identify a set of alert disposition options for the multiple alerts based on the alert types, and estimate probabilities of use for the set of alert disposition options. The instructions further cause the one or more processors to calculate alert disposition risk scores using the estimated probabilities of use of the set of alert disposition options, calculate alert risk scores based on a combination of the alert disposition risk scores for the set of alert disposition options of the multiple alerts, and present two or more of the multiple alerts based on the alert risk scores.

### CROSS-REFERENCE TO RELATED PATENT APPLICATIONS

This application claims priority to and the benefit of U.S. Provisional Patent Application No. 63/168,999 filed Mar. 31, 2021, the entire disclosure of which is incorporated by reference herein.

### BACKGROUND

The present disclosure relates generally to risk management systems for assets (e.g., facilities, buildings, building sites, building spaces, people, cars, equipment, etc.), and more particularly to the prioritization of responses to alerts regarding monitored assets.

Many risk management platforms provide threat information to operators and analysts monitoring all the activities and data generated from facility and building sensors, security cameras, access control systems, fire detection systems, media reporting etc. The data may be an alert, or may be indicative of an event that may pose a risk to a class of assets, or even a particular asset (e.g., a bomb threat). Furthermore, the data may be external, e.g., data from data sources reporting potential threats such as violent crimes, weather and natural disaster reports, traffic incidents, robberies, protests, etc. However, due to the volume of data for the activities and the dynamic nature of the activities, a large amount of resources may be required by the risk management platform to process the data.

Since there may be many alerts and threat events, not only does the security platform require a large amount of resources, a high number of security operators and/or analysts may be required to review and/or monitor the various different alerts and threat events to assess risks posed to assets. Additionally, many alerts may be presented to security operators on an event by event basis without information to place the alert in situational context or to prioritize one alert over others. In some cases, the number of alerts generated by a security system that monitors a large number of sensors becomes overwhelming for security operators because the importance of a given alert in a large number of alerts that lack context and priority cannot be effectively comprehended by a human tasked to determine a timely disposition of the alerts.

### SUMMARY

One embodiment of the disclosure relates to a building security system. The building security system includes one or more memory devices configured to store instructions that, when executed by one or more processors, cause the one or more processors to receive multiple alerts relating to a building. The multiple alerts include alert types. The instructions further cause the one or more processors to identify a set of alert disposition options for the multiple alerts based on the alert types. The instructions further cause the one or more processors to estimate probabilities of use for the set of alert disposition options. The instructions further cause the one or more processors to calculate, for the set of alert disposition options, alert disposition risk scores using the estimated probabilities of use of the set of alert disposition options. The instructions further cause the one or more processors to calculate, for the multiple alerts, alert risk scores based on a combination of the alert disposition risk scores for the set of alert disposition options of the multiple alerts. The instructions further cause the one or more processors to present two or more of the multiple alerts based on the alert risk scores.

In some embodiments, the alert types are associated with alert severity ratings.

In some embodiments, the multiple alerts include a set of alert contextual data. In some embodiments, the set of alert contextual data includes a set of alert metadata, a set of threat data, a set of environmental data, and a set of facility data.

In some embodiments, the set of alert disposition options for the alert types includes a table of one or more actions that a user may select to dispose of an alert. In some embodiments, the table is stored on the one or more memory devices of the building security system.

In some embodiments, the options in the set of alert disposition options are assigned a code. In some embodiments, the code indicates level of security significance.

In some embodiments, the alert risk scores are determined by a dynamic prioritization engine based on inputs comprising an alert type, alert contextual data, a level of security interest, a cost of an asset, a disposition probability, and alert disposition codes applied by a user.

In some embodiments, the disposition probability is estimated by a machine learning model including one or more of a Bayesian network, a neural network, a state vector machine, a decision tree, a hidden Markov model, or a probabilistic relational model.

In some embodiments, the alert contextual data include internal contextual data and outputs of one or more machine learning models. In some embodiments, the one or more machine learning models include a spatial model, an occupancy model, a door classification model, and a sensor state model.

In some embodiments, a classifier engine is trained to calculate the probability of use of an alert disposition option within the set of alert disposition options using historical alert data.

In some embodiments, a classifier engine is periodically retrained to calculate the probability of use of an alert disposition option within the set of alert disposition options using contemporary alert data automatically collected by the system.

Another embodiment of the present disclosure is a method of operating a facility security system. The method includes receiving multiple alerts. An alert of the multiple alerts includes an alert activation signal, an alert type, and a set of alert contextual data. The method further includes identifying a set of alert disposition options for the first alert based on the alert type. The method further includes classifying an alert disposition option for the first alert using a classifier engine. The classifier engine estimates a probability of use of the alert disposition option within the set of alert disposition options based on learned probabilities of the alert disposition option. The method further includes determining an alert risk score for the first alert. The alert risk score aggregates one or more risk model outputs. The one or more risk model outputs is based on an alert disposition option classification, a level of security interest of the alert disposition option, and a cost of loss of an asset monitored by the facility security system. The method further includes prioritizing the first alert based on the alert risk score. The method further includes presenting, through a user interface, a prioritized list of the multiple alerts, the prioritized list comprising the multiple alerts, alert risk scores, and alert disposition options. The method further includes recording the alert disposition option selected by a user for the first alert. The method further includes storing the recorded alert disposition option selections in the classifier engine.

In some embodiments, the alert type is associated with an alert severity rating.

In some embodiments, the multiple alerts further includes a set of alert contextual data, the set of alert contextual data including a set of alert metadata, a set of threat data, a set of environmental data, and a set of facility data.

In some embodiments, the set of alert disposition options for the alert type includes a table of one or more actions that a user may select to dispose of the first alert. In some embodiments, the table is stored on one or more memory devices associated with the facility security system.

In some embodiments, an option in the set of alert disposition options is assigned a code. In some embodiments, the code indicates a level of security significance.

In some embodiments, a disposition probability is estimated by a machine learning model including one or more of a Bayesian network, a neural network, a state vector machine, a decision tree, a hidden Markov model, or a probabilistic relational model.

In some embodiments, the dynamic prioritization engine receives inputs from or more of a contextual machine learning model, a database of historical alert data, alert contextual data, alert disposition data, a database of assets and asset costs, and a threat data service.

In some embodiments, the alert contextual data include internal contextual data and outputs of one or more machine learning models. In some embodiments, the one or more machine learning models includes a spatial model, an occupancy model, a door classification model, and a sensor state model.

In some embodiments, the classifier engine is trained to estimate the probability of use of an alert disposition option within the set of alert disposition options using a first data set.

In some embodiments, the classifier engine is retrained to estimate the probability of use of an alert disposition option within the set of alert disposition options using a second data set. In some embodiments, the second data set includes alert disposition codes applied by a user to alerts and alert contextual data.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a state diagram of a dynamic classifier engine for a security system, according to some embodiments.

FIG. 2 is a process diagram of a method for dynamic alert prioritization, according to some embodiments.

FIG. 3A is block diagram of a security system for a building, according to some embodiments.

FIG. 3B is block diagram showing an example architecture for the security system of FIG. 3A, according to some embodiments.

### DETAILED DESCRIPTION

Virtual Security Operations Centers (VSOC) monitor, often remotely, security systems that oversee sensors of large or complex asset portfolios, where numbers of daily alerts may run to thousands. The security system sensors may detect conditions and occurrences related to health, safety, building function, and operation of a facility or organization. In some embodiments, a VSOC is an autonomous or semi-autonomous system. However, these monitors lack the situational awareness of on-site staff. Various methods exist to improve the sorting and presentation of alert data, so that the more important alerts are highlighted to security monitors. For example, risk models may be used to calculate asset risk scores based on various contextual data, and those scores may be used as priority weighting factors for associated alerts.

In some embodiments, the systems (e.g., a security system) and methods disclosed herein may improve on existing alert prioritization techniques by using internal context data and disposition classifiers to learn how important an alert is likely to be, to alert monitors. Advantageously, improved alert prioritization may support alert disposition decision making of security center operators by placing alerts in a spatial/temporal context and prioritizing alerts based on machine learning derived prediction of the importance of an alert to a user that accounts for previous user dispositions of alerts with similar contexts. These systems and/or methods are be implemented alone, or in combination with other systems and methods.

In some embodiments, a “threat×vulnerability×cost” (TVC) risk assessment model treats “threat” (T) as the probability that a threat is real, “vulnerability” (V) as the probability that the threat, assuming it is real, will succeed, and “cost” (C) as the maximum expected loss that can be suffered, assuming the threat is successful.

In some embodiments, facility alerts including receiving an alert and an alert type may be dynamically prioritized. A set of disposition codes can be identified based on the alert type. The set of disposition codes are classified using, for example, a Bayesian network classifier to estimate the probabilities of use for each disposition code, and to calculate an alert risk score by aggregating, for all disposition codes in the set, the result of a modified TVC risk assessment model. In this modified TVC risk assessment model, Tis a probability score of a disposition code, Vis a measure of a level of security interest in a disposition code, and C is a measure of a cost or loss for a monitored asset. The classifier can be configured for an alert type using inputs from relevant contextual building data. The TVC risk assessment model can be used to score the seriousness of individual alerts, using classifiers (e.g., the Bayesian network classifier) to learn the probabilities of an alert being disposed of in various ways, and analyze historical and live context data.

As described in greater detail below, a set of options for disposing of an alert can be identified from the alert system. These options are typically configured in an alert management system, and are labelled with corresponding disposition codes (see Table 1, below). An alert management system may be deployed as a standalone platform or may be a module in a larger platform including a security system, a building management system (BMS), or an enterprise management system. An alert monitor may take follow-up action in respect of an alert and select the disposition code that best describes the follow-up action. For example, an alert type may be associated with various options to clear or cancel an alert. Depending on the circumstances, an alert monitor may select the relevant disposition code for the action ‘Clear’.

TABLE 1
Examples of common disposition codes in a sample
alert system.
Example Alert Disposition Codes
Clear - Authorized staff onsite, verified via device trace
Clear - Contractor disregard
Clear - TSR/FSR submitted
Clear - Other
Clear - Dispatched Officer
Dispatched Officer - Unconfirmed
Opening closing
Site/POC contacted
Incident Escalation

Each option for dealing with an alert has a different level of security significance to it. For example, an ‘Incident Escalation’ disposition code indicates a response to a highly significant situation. By contrast, a ‘Clear’ disposition code indicates something of much lower security interest.

A classifier can be built for each alert type defined in the alert system. The classifier's function is to learn the probabilities of an alert being disposed of in each of the available options. These options, known by their disposition codes, are harvested from the alert system. Some disposition codes may be specific to the type of alert, while others may apply to all types. Classifier structure may be, for example, a Bayesian network or another suitable type of classifier, such as a neural network, state vector machine, decision tree, hidden Markov model, probabilistic relational model, etc. Classifier structure may include one or more input nodes with associated memory locations for storing input values. In general, a classifier would be selected for its relative simplicity, performance, and how it arrives at its decisions. The classifiers are initially trained on historical alert monitoring and contextual data, and may be re-trained periodically, as more data is gathered. Inputs to the classifier may include context data and the outputs of one or more machine learning models used to interpret and classify certain context data.

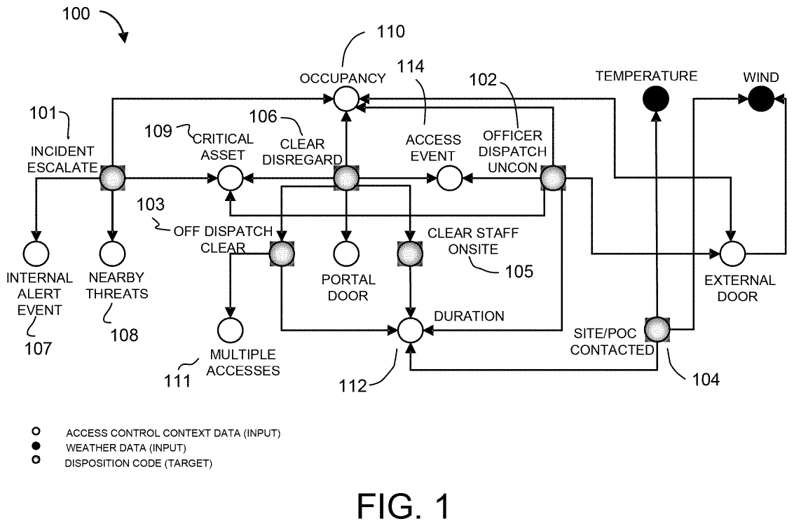

Referring first to FIG. 1, a state diagram a dynamic classifier engine 100 for a security system is shown, according to some embodiments. In some embodiments, dynamic classifier engine 100 is a Bayesian network disposition code classifier, although it will be appreciated that dynamic classifier engine 100 may be implemented using a variety of other types of classifiers. Dynamic classifier engine 100 is constructed of interlinked nodes, which are defined as either inputs or targets. In a security system or alert management system, a range of alert types and associated disposition codes may be stored in a database. In this example, the disposition codes for a Door Held Open (DHO) alert type are the targets to be classified: ‘Incident Escalate’ 101, ‘Officer Dispatch—Unconfirmed’ 102, ‘Officer Dispatch—Clear’ 103, ‘Site Contacted’ 104, ‘Clear—Staff Onsite’ 105, and ‘Clear—Disregard’ 106. The disposition codes relate to six options for disposing of a DHO alert.

Input nodes are constructed to represent relevant contextual data that may be evaluated and used to calculate probabilities that jointly make up the probability that one or more of the target disposition codes will be used. The data type, number, and arrangement of input nodes, and their connections with target nodes, will vary, depending on the alert type. In the example of a DHO alert, relevant context data inputs for estimating a probability that the alert will be assigned an ‘Incident Escalate’ 101 disposition code may include, whether or not the alert was preceded by an internal alert event such as an access event 114. The internal alert event may include, for example, a Door Forced Open (DFO) event, within a certain time 107, whether or not there were any threats or alerts nearby 108, whether or not the door protected a critical asset 109, and the occupancy level of the building 110. Relevant factors in assessing the probability of the alert being cleared with an officer dispatch 103 (i.e. A security monitor decides to dispatch an officer to investigate the alert and assigns a corresponding disposition code.) may include whether or not there were multiple access events occurring while the alert was active 111 and the duration of the alert 112 (which might be pre-classified, for example, as short, medium, or long). Other examples of input node data types are illustrated in dynamic classifier engine 100. Classifier structures, the relationships between nodes, and the weightings of input nodes may initially be based on industry knowledge and experience.

Input data may be processed and categorized using various rules, before being assigned input weights in the classifier. During initial model training, the weights may be randomly assigned or assigned based on reasonable estimates of how important the input data is to a given outcome. Over time, the model learns these input weights.

Other types of input data may be pre-classified before being weighted. For example, the duration of a DHO alert may be classified as short, medium, or long, or the occupancy of a building may be classified as high or low, each with associated weights. Input data may be the output of one or more machine learning models that classify and interpret context data; for example, a spatial model, an occupancy model, and a door classification model.

The classifier calculates the probability of each disposition code for the alert. These values form the T factor of the alert's TVC score. A TVC calculation is carried out in respect of each disposition code, and then the results are aggregated to score the alert relative to other alerts.

In calculating TVC, vulnerability (V) is measured on a scale of how likely it is that an alert monitor would wish to investigate the alert. Each disposition code is assumed to indicate a relative level of security interest in an alert. Therefore, each disposition code is assigned a V (vulnerability) score on a scale reflecting its relative level of security interest.

A V-T matrix is built, relating each disposition code to a number that represents a level of security interest. In the example in Table 2, below, a scale of 0 to 1 is used, with 1 representing the highest level of security interest.

TABLE 2
Example of a V-T matrix (disposition code:
level of security interest)

| Disposition Code (T) | Security Interest (V) |
|---|---|
| Incident Escalation | 1.0 |
| Dispatched Officer - Unconfirmed | 0.9 |
| Dispatched Officer - Clear | 0.8 |
| Site/POC contacted | 0.7 |
| Opening/Closing | 0.6 |

For each alert type, a C value is assigned, reflecting a cost or maximum expected loss, assuming the alert is real. The cost value is normalized to a scale (e.g. 0 to 1) to allow for comparison. For example, a Glass Break alert may have a C value of 0.9, whereas a Duress alert may have a C value of 1.0. The value for C may also be used to prioritize alerts within the same severity range, as explained further below.

For each alert, a TVC calculation is carried out for each disposition code related to the alert type, and the results are aggregated to calculate an individual alert's TVC score. This can be summarized as:

$${\sum }_{Disposition Codes} ( {PDC}_{X} \times {LSI}_{X} \times {Loss}_{max} )$$

where the disposition codes are represented by X, and PDC represents the probability disposition code, LSI represents the level of security interest, and Lossₘₐₓ represents the maximum loss if an alert is determined to be real.

In some cases, severity ranges may be defined for different alert types. These severity ranges can be programmed on individual alert devices, for example. Certain alerts (for example, of the Duress type) may be assigned a higher severity range than other types (for example, DHO alerts). These ranges may overlap, such that an alert at the top of the DHO severity scale may have a higher severity value than an alert at the bottom of the Duress severity scale. Alternatively, alert types may be logically mapped to a predefined set of severity classes. In such a configuration, a Duress alert always has a higher severity rating than a DHO alert.

Assuming that an alert system maintains this primary, ‘hard coded’ severity differentiation, alerts within the same severity range can be prioritized. Each alert's severity range may be calculated by subtracting its minimum severity rating from its maximum severity rating. When calculating each alert's TVC score, the alert's minimum severity rating may be added to the product of the alert's severity range value and TVC score. This can be represented as follows:

SBM+(SRV×(T×V×C))=TVC_{modified}

where SBM represents the severity band minimum and SRV represents the severity range value.

In some embodiments, this method prioritizes alerts within the same severity range. In other embodiments, rules may be configured that, under certain circumstances, escalate alerts to higher severity ranges than their original assigned ranges. Accordingly, this method can be applied to prioritize such alerts.

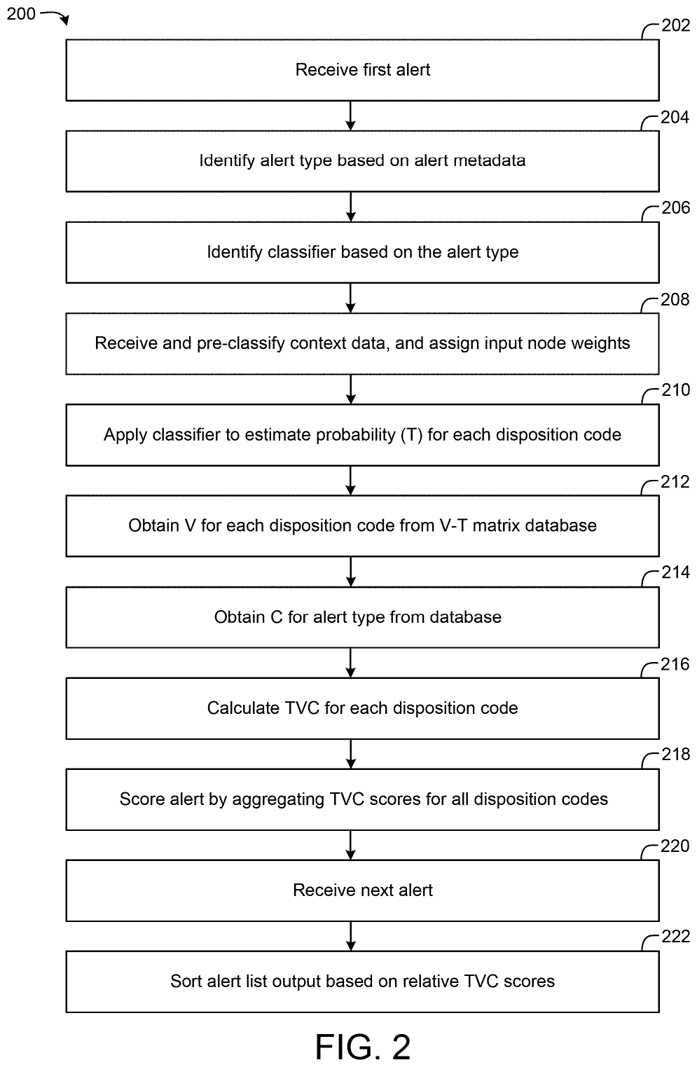

Referring now to FIG. 2, a process diagram of a method 200 for dynamic alert prioritization is shown, according to some embodiments. At step 202, a first alert is received. At step 204, an alert system identifies the alert's type from its metadata and subsequently, at step 206, identifies the relevant classifier for that alert type. At step 208, context data required by the classifier is ingested and pre-classified, before being assigned weights for their associated input nodes. At step 210, the classifier is applied to calculate T for each disposition code. At step 212, for each disposition code, the system retrieves the relevant value for V from the V-T matrix database. At step 214, for each alert type, a value for C is retrieved from a database. At step 216, a TVC calculation is then carried out for each disposition code probability (T). At step 218, these individual TVC scores are aggregated to score the alert against other alerts. At step 220, the process is repeated for the next and subsequent alerts and at step 222, the alert list updates to reflect alert priorities, based on their relative TVC scores. Alert scoring using this method may take place continuously or at short intervals, so that the scores and relative priorities are frequently updated.

In some embodiments, rank alerts using context information may be generated from internal data (as distinct from external data, such as threat alerts). Internal data may include, for example, alerts generated by a BMS, sensor outputs (e.g. thermostat sensed room temperatures or door held open indications from a door position sensor) or alarms generated by an alarm system. In some embodiments, method 200 may be implemented alongside other systems and methods of alert scoring and asset risk analysis to improve the overall ranking of alerts. For example, a risk analysis platform that processes external data may calculate asset risk scores and correlate those data and risk scores with alerts in order to prioritize them. Advantageously, method 200 may improve alert prioritization by adding data generated internally to the asset as additional context.

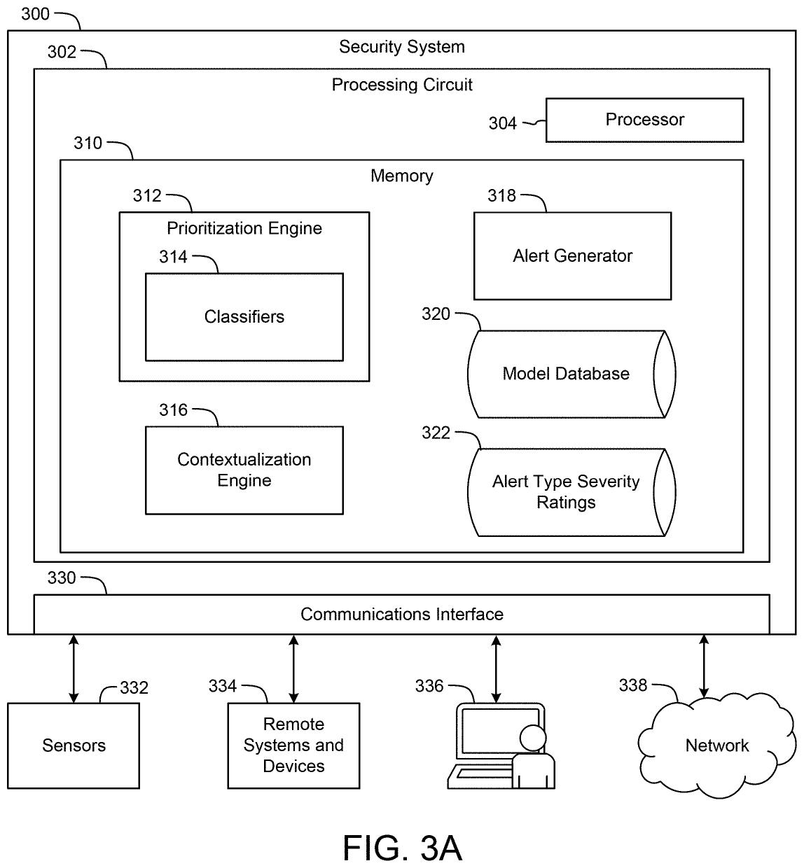

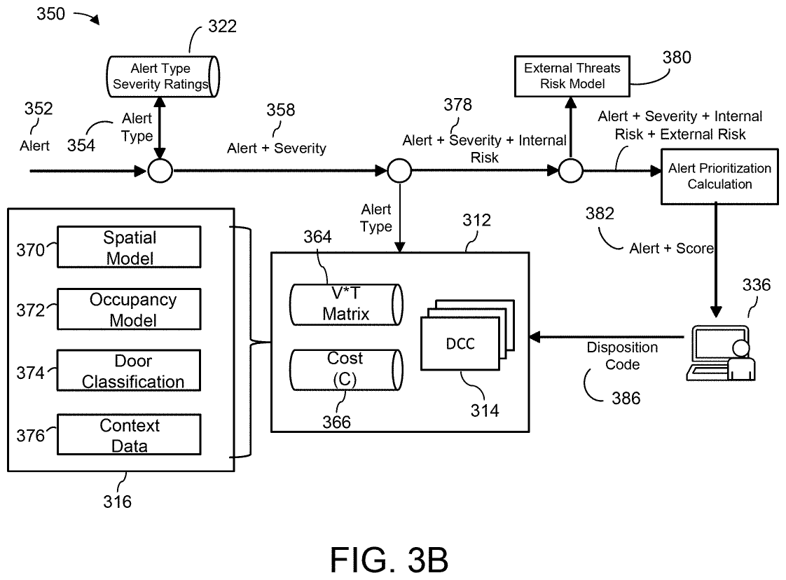

Referring now to FIG. 3A, a block diagram of a security system 300 is shown, according to some embodiments. As described herein, system 300 may also be implemented as, or included in, a risk management or alarm management system for a site (e.g., a building). System 300 can implement, such as by executing computer code stored in a memory by one or more processors, any of the methods and architectures described herein. Advantageously, system 300 can provide improved alarm prioritization by, for example, implementing method 200, described above with respect to FIG. 2. In some cases, system 300 can include classifiers such as dynamic classifier engine 100, described above with respect to FIG. 1.

As shown, system 300 includes a processing circuit 302 that includes a processor 304 and a memory 310. It will be appreciated that these components can be implemented using a variety of different types and quantities of processors and memory. For example, processor 304 can be a general purpose processor, an application specific integrated circuit (ASIC), one or more field programmable gate arrays (FPGAs), a group of processing components, or other suitable electronic processing components. Processor 304 can be communicatively coupled to memory 310 via processing circuit 302. Additionally, while processing circuit 302 is shown as including one processor 304 and one memory 310, it should be understood that, as discussed herein, a processing circuit and/or memory may be implemented using multiple processors and/or memories in various embodiments. All such implementations are contemplated within the scope of the present disclosure.

Memory 310 can include one or more devices (e.g., memory units, memory devices, storage devices, etc.) for storing data and/or computer code for completing and/or facilitating the various processes described in the present disclosure. Memory 310 can include random access memory (RAM), read-only memory (ROM), hard drive storage, temporary storage, non-volatile memory, flash memory, optical memory, or any other suitable memory for storing software objects and/or computer instructions. Memory 310 can include database components, object code components, script components, or any other type of information structure for supporting the various activities and information structures described in the present disclosure. Memory 310 can be communicably connected to processor 304 via processing circuit 302 and can include computer code for executing (e.g., by processor 304) one or more processes described herein.

Memory 310 is shown to include a prioritization engine 312, configured to prioritize alerts for a building as discussed above. In particular, prioritization engine 312 may be configured to receive alert data and alert severity data from an alert generator 318 and/or from any number of other systems or devices (e.g., sensors 332 and/or remote systems and devices 334). Based on the received data, prioritization engine 312 can calculate a TVC score for the alert. In this regard, prioritization engine 312 can include classifiers 314 (i.e., disposition code classifiers) for calculating a T value for each of one or more disposition codes, such as in step 210 of method 200, described above. Prioritization engine 312 may then determine a V value for each of the one or more disposition codes. In some embodiments, prioritization engine 312 retrieves V values from a V-T matrix database, as discussed in detail with respect to FIG. 3B.

Subsequently, prioritization engine 312 can retrieve a C value for the alert type. Again, in some embodiments, the C value may be retrieved from a cost database, as discussed in detail with respect to FIG. 3B. As discussed above, a TVC calculation can be performed for each of the one or more disposition codes associated with an alert, and the results of these calculations can be aggregated to generate a single TVC score for the alert.

In some embodiments, prioritization engine 312 may receive (i.e., ingest) relevant context data from a contextualization engine 316. The context data received from contextualization engine 316 may be utilized as one or more inputs to classifiers 314. Context data may include, for example, output data or values from one or more building and/or equipment models. In some embodiments, contextualization engine 316 may include these one or more models, or may retrieve these models as needed from a model database 320. In this regard, model database 320 may include any number of models for simulating or predicting the behavior of various building spaces, equipment, points, etc. For example, model database 320 can include a spatial model representing one or more spaces (e.g., rooms, hallways, etc.) in the building, an occupancy model representing the occupancy of the building and various spaces within the building at one or more time periods, and a door classifier model for simulating conditions such as DHO, DFO, etc.

It will be appreciated that any number of other models may be included in model database 320, for implementation/execution by contextualization engine 316. It will also be appreciated that these models may be various types of machine learning models, including but not limited to neural networks, linear regression, logistic regression, decision tree, support/state vector machine (SVM), Naive Bayes, hidden Markov, probabilistic relation, random forest, k-means, k-nearest neighbor, etc. Additionally, other context data may also be provided by contextualization engine 316 to prioritization engine 312. Such data may include, for example, metadata associated with the alert or other alerts, and other building/system data.

As mentioned briefly above, alert generator 318 may be configured to receive data, e.g., indicating various operating parameters or alerts, from sensors 332 and/or remote systems and devices 334, and can provide alert data and severity data to the various other components of system 300 (e.g., prioritization engine 312, in particular). In some embodiments, alert generator 318 receives data from sensors 332 and/or remote systems and devices 334, and processes the sensor data to detect and/or generate alerts. For example, sensor data may indicate current parameters for a space or a device (e.g., a door or window sensor), which alert generator 318 can analyze to determine if an alert should be generated. In other embodiments, alert generator 318 receives alerts directly from sensors 332 and/or remote systems and devices 334, and interprets the alert data to determine an alert type, severity, etc.

Sensors 332 can include any type of sensor associated with a space or equipment within a building, and in particular can include sensors for use in building security. For example, sensors 332 can include smoke detectors, temperature and humidity sensors, door position sensors, window position sensors, occupancy detectors, etc. In some embodiments, sensors 332 may also include sensors that are internal to building equipment, such as speed and temperature sensors for a chiller of an HVAC system. Remote systems and devices 334 can include any system or device that is not directly included within system 300, but that can be interfaced with system 300 to provide and/or receive data. For example, remote systems and devices 334 can include a BMS for the building, an external or remote security system, an access control system, a surveillance system (e.g., including cameras and sensors), individual building equipment (e.g., controllers, fire safety devices, lighting components, etc.), or any other type of system or device. Accordingly, it will be appreciated that any type of remote system or equipment is contemplated herein.

Still referring to FIG. 3A, in some embodiments, alert generator 318 also identifies an alert type and/or severity based on alert metadata. For example, alert generator 318 may analyze metadata (e.g., received with an alert, or included in the alert) that provides various parameters associated with the alert, such as alert type, time of occurrence, associated space/equipment/point, etc. In some embodiments, alert generator 318 determines a severity based on an alert type. In such embodiments, alert generator 318 can access an alert type severity ratings database 322 to retrieve a predetermined severity rating based on the alert type. In some embodiments, as mentioned above, alert generator 318 provides an indication of the type and/or severity of an alarm to prioritization engine 312, such that prioritization engine 312 can identify and execute an appropriate classifier (e.g., of classifiers 314).

In some embodiments, system 300 may communicate (e.g., exchange data) with sensors 332 and/or remote systems and devices 334 via a communications interface 330. Communications interface 330 may include wired and/or wireless interfaces (e.g., jacks, antennas, transmitters, receivers, transceivers, wire terminals, etc.) for conducting data communications with various systems, devices, or networks. For example, communications interface 330 may include an Ethernet card and port for sending and receiving data via an Ethernet-based communications network and/or a WiFi transceiver for communicating via a wireless communications network. Communications interface 330 may be configured to communicate via local area networks or wide area networks (e.g., the Internet, a building WAN, etc.) and may use a variety of communications protocols (e.g., BACnet, IP, LON, etc.).

In some embodiments, system 300 may also communicate (i.e., exchange data) with a user device 336 and/or a network 338, in addition to sensors 332 and remote systems and devices 334, as discussed above. User device 336 may be any electronic device that allows a user to interact with system 300 through a user interface. In some embodiments, user device 336 includes at least a user interface capable of presenting visual data (e.g., a screen) and receiving user inputs (e.g., a keypad or keyboard, a touch screen, etc.). Examples of user devices include, but are not limited to, mobile phones, electronic tablets, laptops, desktop computers, workstations, and other types of electronic devices.

Network 338 may be any wired or wireless network that communicably couples various remote or external systems/devices to system 300. For example, network 338 may include an intranet, the Internet, a WAN, a LAN, a VPN, etc. In any case, network 338 provides a route for the exchange of data between system 300 and other components. In some embodiments, any of sensors 332, remote systems and devices 334, and user device 336 may be coupled to system 300 via network 338, rather than directly through communications interface 330.

Referring now to FIG. 3B, a block diagram of an example architecture 350 for system 300 is shown, according to some embodiments. Alert data 352 contains metadata identifying its type, and this type information 354 is used to retrieve associated severity ratings from alert type severity ratings database 322. The alert and severity data 358 is then processed by prioritization engine 312, as described above, to calculate a TVC score for the alert. First, a most-relevant disposition code classifier of classifiers 314 for the alert type is used to calculate a value for T for each of its available disposition codes. Then, the relevant V values for each disposition code are retrieved from the V-T matrix database 364. Finally, the relevant C value for the alert type is retrieved from a cost database 366. A TVC calculation is carried out in respect of each disposition code, and the results are aggregated to form a single TVC score for that alert. In applying the disposition code classifier to the alert, the prioritization engine ingests relevant context data from a contextualization engine 316 for use as classifier inputs. This data may include the outputs of machine learning models, such as a spatial model 370, an occupancy model 372, a door classifier model 374, and/or any of the additional models described above with respect to FIG. 3A

Other internal context data 376 may also be ingested by the classifier. These data may come from metadata of the alert, metadata of other alerts, and other facility or internal system data. The output of the prioritization engine 312 can be an internal alert risk score 378. Architecture 350 also shows the disclosed method working in the context of a broader asset risk model, in some embodiments. Risk score 378 may be viewed as an ‘internal’ alert risk score. The alert may go through further scoring, using another risk model that processes external threat data 380. Both methods may be used together to output an alert priority score. Whether used alone or with an external risk model, an alert score 382 is returned to the alert list and displayed on an alert monitoring user interface, such as user device 336. The system may test and refine its calculations using feedback from alert monitors in the form of disposition codes actually used by alert monitors.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

While the present disclosure is directed towards risk management systems and methods involving assets, e.g. buildings, building sites, building spaces, people, cars, equipment, etc., the systems and methods of present disclosure are applicable to risk management systems and methods for responding to alerts, collection, aggregation, and correlation of alerts and threat data, analysis of alerts as indications of threats, other risk analytics, and risk mitigation for functions, operations, processes, enterprises for which risks can be profiled based on risk related characteristics and parameterized.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A building security system comprising:
one or more memory devices configured to store instructions that, when executed by one or more processors, cause the one or more processors to:
receive a plurality of alerts relating to a building, the plurality of alerts comprising alert types;
identify a set of alert disposition options for the plurality of alerts based on the alert types;
estimate probabilities of use for the set of alert disposition options;
calculate, for the set of alert disposition options, alert disposition risk scores using the estimated probabilities of use of the set of alert disposition options;
calculate, for the plurality of alerts, alert risk scores based on a combination of the alert disposition risk scores for the set of alert disposition options of the plurality of alerts; and
present two or more of the plurality of alerts based on the alert risk scores.

2. The system of claim 1, wherein the alert types are associated with alert severity ratings.

3. The system of claim 1, wherein the plurality of alerts further comprise a set of alert contextual data, the set of alert contextual data comprising a set of alert metadata, a set of threat data, a set of environmental data, and a set of facility data.

4. The system of claim 1, wherein the set of alert disposition options for the alert types comprises a table of one or more actions that a user may select to dispose of an alert, wherein the table is stored on the one or more memory devices of the building security system.

5. The system of claim 4, wherein the options in the set of alert disposition options are assigned a code, the code indicating a level of security significance.

6. The system of claim 1, wherein the alert risk scores are determined by a dynamic prioritization engine based on inputs comprising an alert type, alert contextual data, a level of security interest, a cost of an asset, a disposition probability, and alert disposition codes applied by a user.

7. The system of claim 6, wherein the disposition probability is estimated by a machine learning model comprising one or more of a Bayesian network, a neural network, a state vector machine, a decision tree, a hidden Markov model, or a probabilistic relational model.

8. The system of claim 6, wherein the alert contextual data comprise internal contextual data and outputs of one or more machine learning models, the one or more machine learning models further comprising a spatial model, an occupancy model, a door classification model, and a sensor state model.

9. The system of claim 1, wherein a classifier engine is trained to calculate the probability of use of an alert disposition option within the set of alert disposition options using historical alert data.

10. The system of claim 1, wherein a classifier engine is periodically retrained to calculate the probability of use of an alert disposition option within the set of alert disposition options using contemporary alert data automatically collected by the system.

11. A method of operating a facility security system, the method comprising:
receiving a plurality of alerts, wherein a first alert of the plurality of alerts comprises an alert activation signal, an alert type, and a set of alert contextual data;
identifying a set of alert disposition options for the first alert based on the alert type;
classifying an alert disposition option for the first alert using a classifier engine, wherein the classifier engine estimates a probability of use of the alert disposition option within the set of alert disposition options based on learned probabilities of the alert disposition option,
determining an alert risk score for the first alert, wherein the alert risk score aggregates one or more risk model outputs, further wherein the one or more risk model outputs is based on an alert disposition option classification, a level of security interest of the alert disposition option, and a cost of loss of an asset monitored by the facility security system;
prioritizing the first alert based on the alert risk score;
presenting, through a user interface a prioritized list of the plurality of alerts, the prioritized list comprising the plurality of alerts, alert risk scores, and alert disposition options;
recording the alert disposition option selected by a user for the first alert; and
storing the recorded alert disposition option selections in the classifier engine.

12. The method of claim 11, wherein the alert type is associated with an alert severity rating.

13. The method of claim 11, wherein the plurality of alerts further comprise a set of alert contextual data, the set of alert contextual data comprising a set of alert metadata, a set of threat data, a set of environmental data, and a set of facility data.

14. The method of claim 11, wherein the set of alert disposition options for the alert type comprises a table of one or more actions that a user may select to dispose of the first alert, wherein the table is stored on one or more memory devices associated with the facility security system.

15. The method of claim 14, wherein an option in the set of alert disposition options is assigned a code, wherein the code indicates a level of security significance.

16. The method of claim 11, wherein a disposition probability is estimated by a machine learning model comprising one or more of a Bayesian network, a neural network, a state vector machine, a decision tree, a hidden Markov model, or a probabilistic relational model.

17. The method of claim 16, wherein the dynamic prioritization engine receives inputs from or more of a contextual machine learning model, a database of historical alert data, alert contextual data, alert disposition data, a database of assets and asset costs, and a threat data service.

18. The method of claim 17, wherein the alert contextual data comprise internal contextual data and outputs of one or more machine learning models, the one or more machine learning models further comprising a spatial model, an occupancy model, a door classification model, and a sensor state model.

19. The method of claim 11, wherein the classifier engine is trained to estimate the probability of use of an alert disposition option within the set of alert disposition options using a first data set.

20. The method of claim 11, wherein the classifier engine is retrained to estimate the probability of use of an alert disposition option within the set of alert disposition options using a second data set, the second data set comprising alert disposition codes applied by a user to alerts and alert contextual data.
